(19) United States
(12) Patent Application Publication
(10) Pub. No.: US 2006/0123388 A1
(43) Pub. Date: Jun. 8, 2006

(54) System and method for supporting embedded software development methodology with quantitative process management

(76) Inventors: Yoon Jung Choi, Dalseong-Gun (KR); Su Jung Ha, Daejeon (KR); Jin Sam Kim, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/271,001

(22) Filed: Nov. 10, 2005

(30) Foreign Application Priority Data
Dec. 7, 2004 (KR) 2004-102498

(51) Int. Cl. G06F 9/44

(52) U.S. Cl. 717/101; 717/120

(57) ABSTRACT

System and method for supporting an embedded software development methodology with quantitative process management are provided. The system and method support a development methodology for effectively defining, referring, and applying an embedded software development methodology that can economically and timely develop a high quality embedded software. Therefore, the system and method can support so that a quantitative approach may be possible for other embedded software development and management thereof afterward by managing techniques and criteria capable of analyzing information obtained through accumulation of quantitative project data related to the embedded software development.

### BACKGROUND OF THE INVENTION

1. Field of the Invention

The present invention relates to system and method for supporting an embedded software development methodology with quantitative process management, and more particularly, to system and method for supporting an embedded software development methodology with quantitative process management, capable of activating introduction and application of a development methodology on the basis of a fundamental research regarding development of an embedded software development framework and supporting process improvement through a quantitative project management.

2. Description of the Related Art

In the aspects of functionality, the conventional methodology user support system allows a methodology user within an organization to refer the definition of a development process and the content of a methodology for each item without limitation in time and space on the basis of the content provided in the form of a database, instead of referring to the conventional manual in the form of a document, allows a methodology user to select and tailor the methodology for each project appropriate for the project context, and allows a methodology user to search and refer to the content of the methodology that has been applied to a terminated project and project data thereof.

However, there has been no tool for completely supporting definition, measurement, and analysis of metrics for quantitative process and project management as well as supporting efficient definition, reference, and application of methodology. Therefore, such a tool is highly required.

### SUMMARY OF THE INVENTION

Accordingly, the present invention is directed to system and method for supporting an embedded software development methodology with quantitative process management, which substantially obviate one or more problems due to limitations and disadvantages of the related art.

It is an object of the present invention to provide a technique capable of providing a quantitative process and a project management function as well as basic functions (definition, reference, application, and a guide of the development methodology) which should be provided to a development methodology support system, and system and method for supporting an embedded software development methodology with quantitative process management, capable of achieving the above technique.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a system for supporting an embedded software development methodology with quantitative process management, the system including: a methodology management tool for defining a construction of an embedded software development methodology, managing a process and an element including a construction of the development methodology, generating an electronic manual and a document manual of the development methodology, and defining and managing a method for improving a process and the related metrics for each process; a project management tool for establishing a plan on the basis of a methodology for a new project, monitoring a progress of the project, performing an upload of related work products when the project is in progress, and appraising a performance degree of the project; and an asset management tool for registering and managing assets worth being reused among project data of the project management tool, and supporting searching of the registered assets.

In another aspect of the present invention, there is provided a method for supporting an embedded software development methodology with quantitative process management, the method including the steps of: (a) providing embedded software development methodologies and basic information of a process, constructing a process structure in hierarchical concepts, and defining and connecting the related work products, techniques, and a role one another for a leaf node process in hierarchical process structure using a methodology management tool; (b) selecting and tailoring a development methodology to apply among the development methodologies so as to register a new project; (c) sharing the selected development methodology to perform a new project and generate project data; and (d) registering and managing an asset worth being reused from the project data.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention, are incorporated in and constitute a part of this application, illustrate embodiments of the invention and together with the description serve to explain the principle of the invention. In the drawings:

FIG. 1 is a view of an entire construction of a system for supporting an embedded software development methodology;

FIG. 2 is a view of a methodology management tool for supporting defining, tailoring of a development methodology, and generating of an electronic manual among the objects of the present invention;

FIG. 3 is a view of a project management tool for supporting quantitative process management through metric management among the objects of the present invention; and

FIG. 4 is a view a diagram illustrating a series of activities that can be performed through a system for supporting an embedded software development methodology.

### DETAILED DESCRIPTION OF THE INVENTION

Reference will now be made in detail to the preferred embodiments of the present invention, examples of which are illustrated in the accompanying drawings.

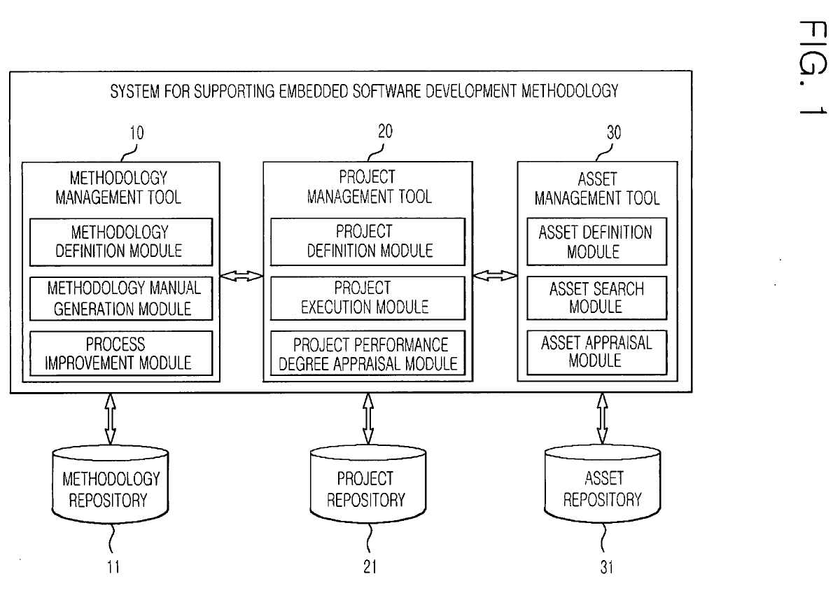

FIG. 1 is a view of an entire construction of a system for supporting an embedded software development methodology. Referring to FIG. 1, the system includes a methodology management tool 10, a project management tool 20, and an asset management tool 30.

The methodology management tool 10 includes a methodology definition module, a methodology manual generation module, and a process improvement module. The project management tool 20 includes a project definition module, a project execution module, and a project performance evaluation module. The asset management tool 30 includes an asset definition module, an asset search module, and an asset evaluation module.

Also, the methodology management tool 10 further includes a methodology repository 11, the project management tool 20 further includes a project repository 21, and the asset management tool 30 further includes an asset repository 31.

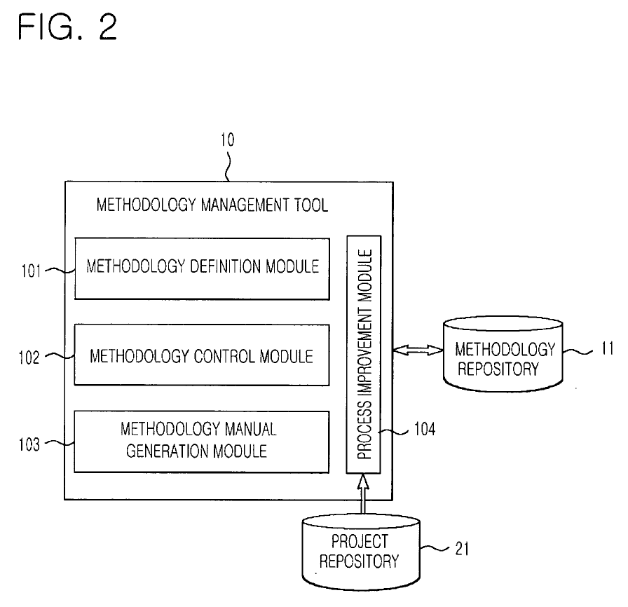

FIG. 2 is a view of a methodology management tool for supporting defining, tailoring of a development methodology, and generating of an electronic manual among the objects of the present invention. Referring to FIG. 2, the methodology management tool 10 includes a methodology definition module 101 for defining an element of a methodology, a methodology tailoring module 102 for tailoring a process and other elements according to the project context, a methodology manual generation module 103 for generating an electronic manual and a document manual of a methodology, a process improvement module 104 for providing a method for improving a process, defining and managing metrics for each process, and a methodology repository 11.

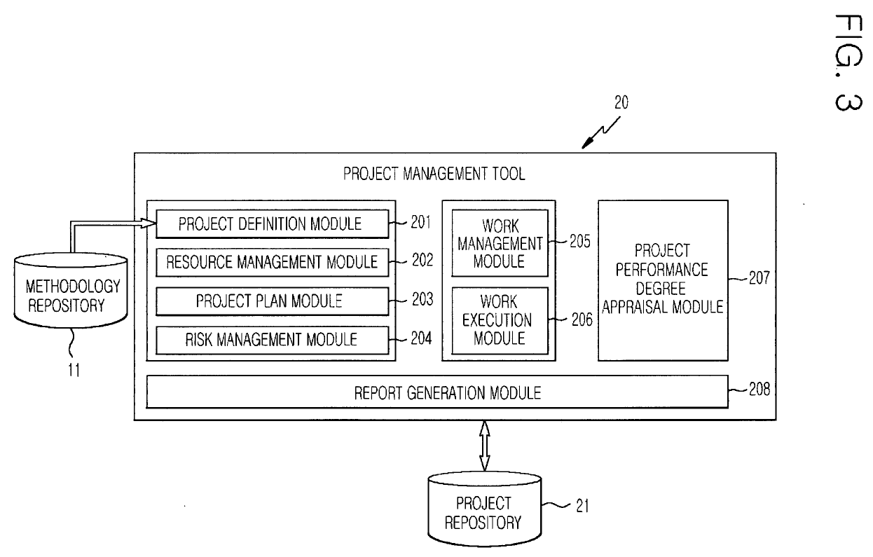

FIG. 3 is a view of a project management tool for supporting quantitative process management through metric management among the objects of the present invention. Referring to FIG. 3, the project management tool 20 includes a project definition module 201 for registering basic information of a new project and defining an element of a project, a resource management module 202, a project plan module 203 for estimating, scheduling, and re-scheduling a project, a risk management module 204 for managing a risk, an issue trace of a project, a work management module 205 for managing progress status of a project, a work execution module 206 for supporting execution of a project, a project performance evaluation module 207, a report generation module 208, and a project repository 21.

According to the present invention, an approach to process improvement is dealt with from a viewpoint of metrics. To achieve the object of the present invention, in more detail, the process improvement module 104 has close relationship with the process of defining metrics in an aspect of methodology management and the process of planning, measuring, and the process of analyzing result thereof in an aspect of a project management.

In an organization where a process is defined in a methodology and management for a process is performed, measurement by a metric is indispensable so as to be appraised as a higher-level process because quality of a process and a product can be visualized and managed by measurement. Therefore, to measure how well a preformed process has been carried out, deviation obtained by comparing an expected object and a result thereof is analyzed and interpreted to understand what to improve. After a planned improvement activity is performed, the performed process is re-evaluated to check whether a better result is obtained. Also, results of measurement work is collected in a process unit as well as a project unit over a whole company, and integrated for each department or each domain, so that the results are analyzed and reflected in improving the process. The defining of a metric describes a measurement object, accurately defines a metric indication value, i.e., an indicator, and allows the indicator to judge whether a statistical processing is meaning or not according to a predetermined scale (e.g., ratio, interval, ordinal, nominal, etc.). Also, the defining of a metric defines a measurement process of a metric and a recording method, makes a format for storing and collecting data, and defines through what process a data value is found out and what is an available tool. Also, the measurement and analysis of a metric change according to a scale and is connected to a decision-making for process improvement. The range within an organization, the schedule, and the format in which analyzed result is reported are defined.

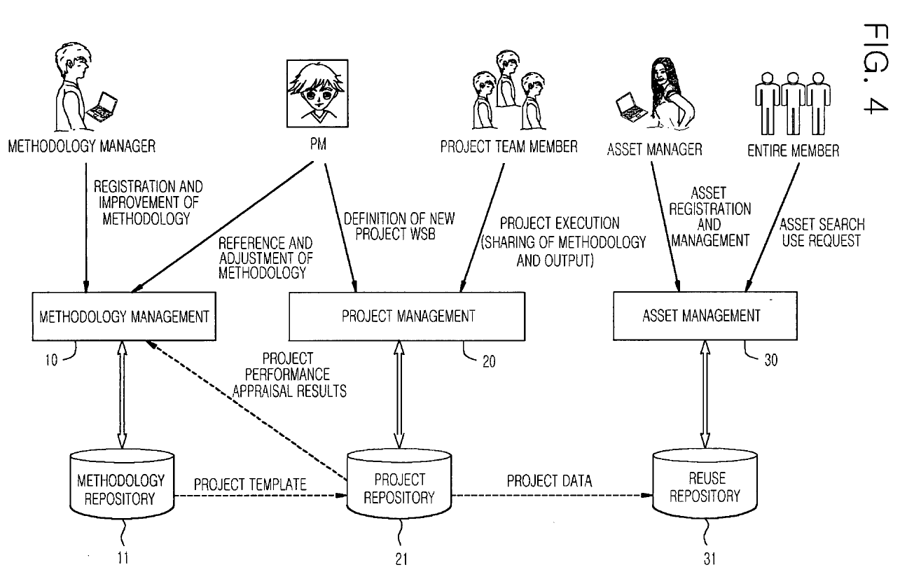

A method for supporting an embedded software development methodology with quantitative process management having the above construction will be described with reference to FIG. 4.

FIG. 4 is a view a diagram illustrating a series of activities that can be performed through a system for supporting an embedded software development methodology. Referring to FIG. 4, a methodology manager defines and connects the construction of a process structure, work products, techniques, tools, and a role for leaf node process as methodology, basic information of a process, and its hierarchical concepts. A project manager (PM) selects and tailors methodology to apply for simple reference to information of methodology registered in the methodology repository 11 and registration of a new project, thereby defining work breakdown structure (WBS). A team member of a project shares methodology and makes an output thereof while performing a project, and then the output in the project repository 21. An asset manager registers an asset worth being reused from project data in the asset repository 31 and manages the asset. A user as a member of an entire organization makes a use request and receives approval thereof through searching of registered assets and then views and downloads the asset.

As described above, the system and method for supporting an embedded software development methodology with quantitative process management according to the present invention can efficiently manage project performance and conduct quantitative process management using embedded software development methodology. That is, the present invention can reinforce function by performing process improvement through quantitative project management as well as providing basic functions (definition, reference, application, and a guide of the development methodology).

Moreover, it is expected that a process ability level 4 is achieved on the basis of a standard software process model such as Standard Process Improvement and Capability determination (ISO/IEC) 15504 and Capability Maturity Model Integration (CMMI) besides the above mentioned function.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A system for supporting an embedded software development methodology with quantitative process management, the system comprising:
a methodology management tool for defining a construction of an embedded software development methodology, tailoring a process and an element including a construction of the development methodology, generating an electronic manual and a document manual of the development methodology, and defining and managing a method for improving a process and metrics for each process;
a project management tool for establishing a plan on the basis of a methodology for a new project, monitoring a progression status of the project, performing an upload of related work products when the project is in progress, and evaluating the project performance; and
an asset management tool for registering and managing assets worth being reused among project data of the project management tool, and supporting searching of the registered assets.

2. The system of claim 1, wherein the methodology management tool comprises:
a methodology definition module for defining methodology elements;
a methodology tailoring module for tailoring a process and an element according to the characteristics of a project;
a manual generation module for generating an electronic manual and a document manual of the methodology;
a process improvement module for defining and managing a method for a process improvement, and metrics for each process; and
a methodology repository for storing the methodology elements and metric definition data.

3. The system of claim 1, wherein the project management tool comprises:
a project plan module for establishing a plan regarding a methodology-based task so as to perform a new project;
a task management module for monitoring and controlling a task on a project plan and managing a progress status of a task assigned to a team member of each project;
a task performing module for checking-in and checking-out a related file when a project performer performs a task on the project plan and uploading a file when the file is made completely; and
a project performance evaluation module for appraising a performance degree associated with actual results versus a plan in a performed task with respect to a terminated project, reflecting importance of respective tasks according to task evaluation guidelines and criteria to integrate and calculate final task evaluation results.

4. The system of claim 3, wherein the project management tool further comprises:
a project definition module for registering basic information of a new project and defining an organization;
a resource management module for managing resources;
a risk management module for performing a trace management for a risk and an issue of a project; and
a report generation module for generating a report according to performance of a project.

5. The system of claim 3, wherein the project management tool further comprises a project repository for storing a file uploaded from the task performing module and performance result data of the project performance degree appraisal module.

6. The system of claim 1, wherein the asset management tool comprises:
an asset definition module for defining an asset;
an asset search module for support searching of assets in response to a search request;
an asset appraisal module for appraising an asset worth being reused from project data; and
an asset repository for storing the asset worth being reused.

7. A method for supporting an embedded software development methodology with quantitative process management, the method comprising the steps of
(a) providing embedded software development methodologies and basic information of a process, constructing process structure using hierarchical concepts, and defining and connecting work products, techniques, and a role one another for leaf node process using a methodology management tool;
(b) selecting and tailoring a development methodology to apply among the development methodologies so as to register a new project;
(c) sharing the selected development methodology to perform a new project and generate project data; and
(d) registering and managing an asset worth being reused from the project data.

8. The method of claim 7, wherein the step (c) comprises:
(c1) monitoring and controlling a task when the task on a project plan is performed;
(c2) checking-in and checking-out a related file when the task on the project plan is performed and uploading a file when the file is made completely; and
(c3) evaluating a project performance associated with actual results versus a plan in a performed task with respect to a terminated project.

9. The method of claim 8, wherein the step (c) further comprises, after the step (c3), the step of reflecting importance of respective tasks according to task evaluation guidelines and criteria to integrate and calculate final work appraisal results.

10. The method of claim 7, further comprising, after the step (d), the step of viewing and downloading an asset after making a use request and receiving approval thereof through searching of registered assets.
